(19) United States
(12) Patent Application Publication
(10) Pub. No.: US 2006/0016161 A1
(43) Pub. Date: Jan. 26, 2006

(54) Saddle fender bender

(76) Inventor: Monte B. Willis, Hurricane, UT (US)

Correspondence Address: M. REID RUSSELL, 854 WEST 3390 SOUTH, HURRICANE, UT, 84737, US

(21) Appl. No.: 10/774,007

(22) Filed: Feb. 9, 2004

(51) Int. Cl. B68C 1/16

(52) U.S. Cl. 54/46.1

(57) ABSTRACT

A saddle fender bender for forming and maintaining a bend of approximately a ninety degree arc in a leather saddle fender lower forward portion that consists of a metal bar that is bent into an arc of approximately ninety degrees and includes tapped holes or internally threaded posts formed or attached, at spaced intervals along, the bar inner surface that align with, or fit through holes, formed through the fender and are each to receive a threaded end of a broad head bolt fitted and turned therein to where each bolt broad head undersurface engages and presses into the fender, maintaining the fender bender to the fender.

### BACKGROUND OF THE INVENTION

1. Field of the Invention

The present invention pertains to riding saddles and in particular to an arrangement for bending and maintaining a saddle fender leading edge outwardly, maintaining the saddle stirrup positioned at a right angle outwardly from a horse that the saddle is mounted onto.

2. Prior Art

Saddles and components thereof are very well know in the art and generally include a saddle fender that is maintained to a stirrup leather, mounting a stirrup to its lower end. Such saddle fender provides for positioning of the stirrup relative to the horse, with optimally, the stirrup to extend approximately perpendicularly outwardly from the horse. To provide for desired stirrup positioning, the fender leading edge portion has, in the past, been bent during saddle construction to curve outwardly across a forward portion of a rider's lower leg. So arranged, the fender bent portion rotates a lower portion of the saddle stirrup leather that the stirrup hangs from to extend essentially perpendicular to the horse's body. In practice, however, over time, and with the saddle exposed to water, the curve in the fender softens, with the leather of the fender straightening, to where the stirrup is essentially parallel to the horse.

For a rider to mount a horse whereof the saddle is mounted, the rider positions their left foot in the left stirrup and swings their right leg over the horse. With the right stirrup parallel to the horse, the rider will find it difficult to locate and position their foot in the stirrup. Further, during riding, should a rider lose their foot out of a stirrup, it is difficult to reposition their foot in that stirrup with the stirrups positioned parallel to the horse. The invention provides for forming and maintaining the saddle fenders lower leading edge portions in a bent attitude, insuring proper stirrup positioning, over the life of the saddle.

### SUMMARY OF THE INVENTION

The invention is in a saddle fender bender that is a curved bar arranged for attachment to a saddle fender surface away from a rider seated in the saddle and is to maintain an outward curve along the lower fender leading edge. Which outward bend in the fender tends, in turn, to maintain the attached stirrup leather extending outwardly, at approximately a right angle, from a body of a horse whereon the saddle is fitted. The saddle has right and left stirrups that each fit to the stirrup leather maintained to each saddle fender that is bent at its leading portion, with the attached stirrup thereby maintained at approximately a right angle outwardly from the horse. So arranged, the stirrup opening is convenient for a rider to fit their foot in, in both mounting and during riding the horse. The curved bar has approximately a ninety degree arc formed therein and, for mounting to the fender, includes posts that are internally threaded or is drilled and tapped to receive threaded ends of broad headed bolts turned therein. The posts can be soldered, brazed, or otherwise connected to, to extend outwardly, at spaced intervals from along the back or inner curved surface of the curved bar and are for fitting through holes punched in, or otherwise formed through the leather fender. Whereafter, broad headed bolts are fitted into the fender holes and turned into tight fitting engagement within the posts or into the tapped holes, such that the bolt broad head ends are turned into the leather surface, locking the curved bar in place. To facilitate which bolt tightening, the bolt heads preferably include slots formed across their outer surfaces or tool recessed to receive a flat or keystone type bit end of a conventional screw driver, or Alan wrench, to turn the bolt into tight fitting engagement with the fender surface. So arranged fender bender of the invention will maintain the saddle fender leading edge portion in a bent attitude over the saddle life.

It is a principal object of the present invention to provide an appliance for bending and permanently maintaining a bend formed in each of two saddle fenders that is back from the fender leading edge, extending up from near the stirrup.

Another object of the present invention is to provide a curved bar as the fender bender appliance having an arc of approximately ninety degrees around the bar inner surface that includes internally threaded posts or tapped holes, with the posts or tapped holes arranged, at spaced interval along the bar inner surface, and with the posts extending at approximately right angles therefrom to receive threaded ends of broad headed bolts turned therein that have been fitted through holes formed through the leather fender, locking each curved bar to the fender lower portion to maintain a fender leading edge at approximately a right angle outwardly.

Still another object of the present invention is to provide, for turning the bolts head ends under surfaces into tight fitting engagement with the leather fender surface, screw driver receiving slots formed in and extending across each bolt head end, or providing a sided tool receiving opening formed into the center of the head end to receive a tool, such as an Alan wrench.

Still another object of the present invention is to provide heads for each bolt that have attractively decorated outer surfaces.

### BRIEF DESCRIPTION OF THE DRAWINGS

These and other objects and features of the present invention will become more apparent from the following description in which the invention is described in detail in conjunction with the accompanying drawings:

FIG. 1 is a side elevation view of a mid-section of a horse taken from the left side of the horse whereon a saddle is mounted, showing the left side of the saddle as including a leather fender whose lower forward edge portion is bent outwardly, with the fender shown as maintaining a stirrup hung therefrom at, approximately, a right angle with the side of the horse, showing bolt head ends at spaced intervals across a lower portion of the fender, and showing, in broken lines, a curved bar that is the fender bender of the invention wherein threaded ends of the bolts are turned;

FIG. 2 shows a side elevation view of the leather fender, stirrup leather and stirrup of FIG. 1 with the curved surface of the fender bender shown in broken lines bent at an angle alpha and with the broad head bolts, after passage through spaced holes formed through the fender, as having been turning into tight fitting engagement with the holes edges;

FIG. 3 is an enlarged top plan view of the fender bender of the invention removed from the saddle leather fender;

FIG. 4 is an enlarged sectional view taken along the line 4-4 of FIG. 2, showing the fender bender of the invention mounted to the saddle leather fender;

FIG. 5 is a view like that of FIG. 3 only showing the fender bender bolt head ends as including transverse slots that are for receiving a flat keystone type screw driver end fitted therein to turn the bolts threaded ends into spaced holes formed and tapped into the fender bender; and

FIG. 6 shows a sectional view like that of FIG. 4 showing the fender bender of FIG. 5 mounted to the saddle leather fender.

### DETAILED DESCRIPTION

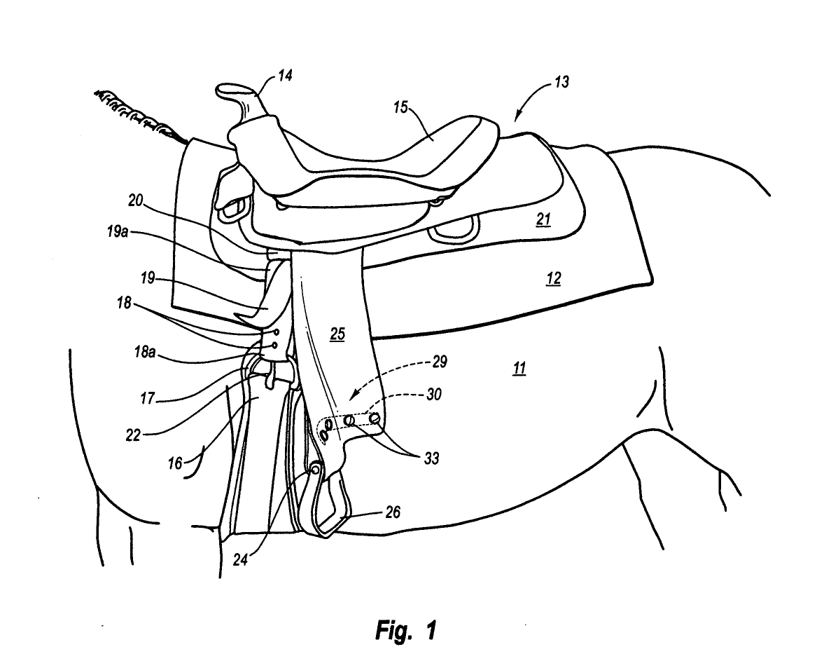

The invention, as is hereinafter described, relates to leather saddles and in particular to an arrangement of a fender bender for bending and maintaining a bend in a lower forward portion of a saddle fender. Shown in FIG. 1 is a mid-section of a horse 11 that has had a saddle blanket 12 fitted across its back, with a saddle 13 positioned thereon. The saddle 13 is shown as a western saddle having a saddle horn 14 extending upwardly from a forward or swell fork end of a seat 15, and includes a leather tie strap 18 that is shown connected, by a forward buckle 17, to a cinch 16. The leather tie strap has spaced holes 18a formed therealong, with a strap end 19 shown passed through a rigging ring 20 that is formed through a saddle skirt 21 forward portion. The saddle 13 position on a horse's back is mounted thereto utilizing a leather tie strap upper end 19a that is attached to the saddle skirt 21 at rigging ring 20. The strap end is fitted through the forward buckle 17 and, when tight, a buckle tongue or prong 22 is fitted into a selected cinch strap hole 18a. This holds the buckle to the leather tie strap 16, and the tie strap end is then passed through the rigging ring 20.

The saddle 13, as shown in FIG. 1, includes stirrups 26 that are each for maintaining a riders foot to the saddle 13, with each stirrup suspended from each of two saddle stirrup leathers 23 that each connect, on its upper end, to the saddle skirt 21, not shown. Each stirrup leather is also connected, as with rivets, not shown, to a lower portion of a saddle fender 25, hanging from the saddle fender lower end. Each stirrup 26 is formed as a rigid U-shaped section that receives a pin 24 fitted across the U open ends that one of the stirrup leathers is passed under, suspending the stirrup. A pivot mounting of the stirrup to the stirrup leather loop is thereby provided. Each stirrup is for receiving a rider's shoe or boot fitted into the stirrup during mounting and riding. In practice, a rider, to mount the horse, fits their left foot in the left stirrup, pivots their right leg over the horse's back and fits their right foot in the right stirrup. Where, in mounting, the rider can see the left stirrup they cannot see the right stirrup until they are seated in the saddle 13. Accordingly, to facilitate finding the right stirrup to fit their foot in, it is desirable that the right stirrup extend at essentially a right angle outwardly from the horse. To provide which stirrup 26 positioning, fender benders 29 of the invention, as set out below, are fitted to each of the fenders 25, lower portion and provide for maintaining the two stirrups each at a right angle attitude to the side of the horse 11.

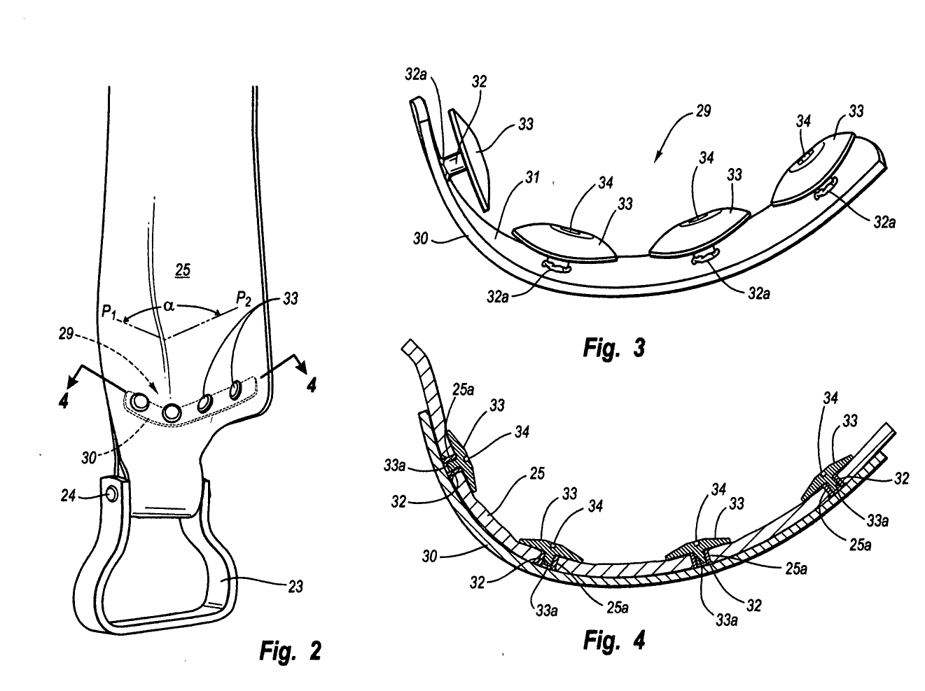

FIG. 1 shows the fender bender 29 of the invention in broken lines as including a bar wherein has been formed an arch that is for fitting to the fender undersurface away from the horse, of each of the pair of the fenders 25. The bar 30 is shown as extending across the fender 25 though, it should be understood, can extend partially across the fender 25, within the scope of this disclosure. Shown in FIGS. 3 and 4, the bar is attached to the horse side of the fender along its arched surface 31 by bolts that are shown as having heads 33 wherefrom threaded shafts 33a extend from each head undersurface. The threaded shafts 33a are each to turn into a straight post 32 that, as shown in FIGS. 3 and 4, are each secured at its end 32a, at spaced intervals, to the arched inner surface 31 of the bar 30. Which attachment of the post 32 ends 32a is preferably by soldering or brazing, but, in should be understood, can be by any appropriate process or procedure. The posts 32, as shown best in FIG. 4, are for fitting through individual spaced holes 25a that have been punched or otherwise formed, at spaced intervals, through the leather fender 25, across a lower portion thereof, as shown in FIG. 2. Thereafter, the bolts threaded shafts 33a are fitted into the posts 32 open ends and are turned into the post threaded interior to where the broad heads 33 undersurface engage and are turned into the fender 25 surface. The fender bender is thereby mounted onto a forward surface of the fender 25 and maintains a bend in the fender 25 lower forward portion, as shown in FIGS. 1 and 2.

The bent lower forward portion of the fender 25 maintains the stirrup strap 23 alongside the horse's mid-section, positioning the stirrup suspended from the stirrup leather end at a right angle to the horse's mid-section, facilitating a riders positioning and maintaining their foot in the saddle both in mounting the horse and during riding.

The fender bender 29 bar 30 is preferably formed from a section of square or rectangular metal bar stock, such as steel, that has a length to extend across or nearly across the fender 25 lower portion. The bar 30 is bent across its longest parallel sides into an arc of approximately ninety (90) degrees. So arranged, the bar arched surface is formed to fit against the inner surface of the fender 25, as shown in FIGS. 1 and 2. To provide a tight coupling of the bar 30 onto the fender 25, an operator turns the bolts threaded portions 33a into the threaded posts 32 as by gripping the edge of each broad head 33 between their fingers. Alternatively, as shown in FIGS. 3 and 4, each bolt head end 33 can include a sided recess for receiving an end of a tool, such as an Allan wrench, fitted therein for turning the head end into tight fitting engagement with the fender outer surface that is contacted by a riders lower leg.

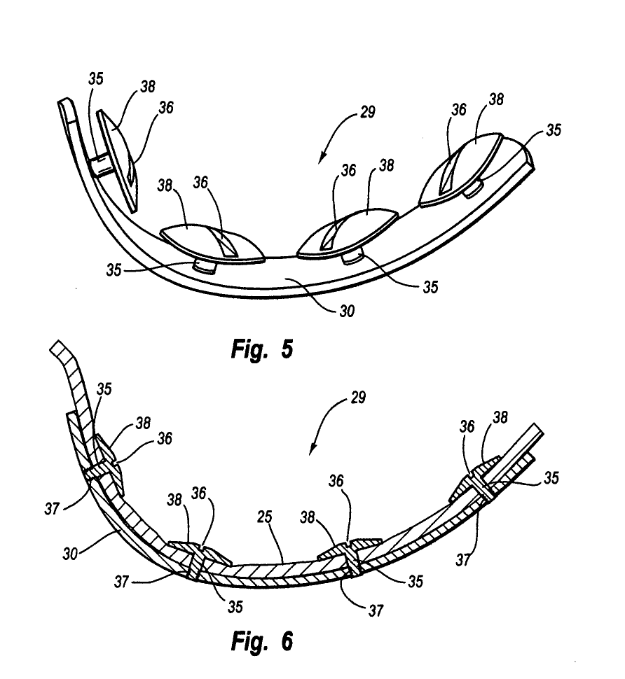

FIGS. 5 and 6 show another configuration of the fender bender 29 where, shown in FIG. 6, the bar 30 is tapped and threaded at 37 at intervals along its arched fender engaging surface to receive bolts threaded ends 35, and with the bolt heads 38 are each shown as including a lateral slot 36 formed thereacross that is to receive, and be turned by, a keystone type bit end of a conventional screw driver, not shown.

While the bolt heads 33 and 38 have been set out as having arrangements for receiving turning tools to allow for their tightening against the fender surface, it should be understood that such are not required and the bolt broad heads can be finger tightened into engagement with the fender surface, within the scope of this disclosure. Also, the bolt head ends 33 and 38 can receive a decorative pattern, or the like, scribed, etched, or otherwise formed, therein to accompany and complement other saddle decorations, within the scope of this disclosure.

Hereinabove has been set out a description of a preferred saddle fender bender of the invention. It should however, be understood that the present invention can be varied within the scope of this disclosure without departing from the subject matter coming within the scope of the following claims, and a reasonable equivalency thereof, which claims 1 regard as my invention.

I claim:

1. A saddle fender bender comprising, a bar formed from a straight section of metal bar stock that is bent to have and retain an arc of approximately ninety (90) degrees and having a length to extend at least partially across a lower portion of a saddle fender; a plurality of bolts each having a broad head end and is threaded along a bolt shaft; means secured at spaced interval along an inner arc surface of said bar for receiving each said bolt threaded shaft end turned therein to position said bolt broad head end undersurface into engagement with an outer surface edge of a hole formed through said fender wherethrough said bolt is passed.

2. The saddle fender bender as recited in claim 1, the bar has a rectangular cross section and is bent across its longest parallel sides.

3. The saddle fender bender as recited in claim 1, further including posts that are each internally threaded and are connected, at spaced intervals along, to extend at approximately right angles outwardly from, the bar inner arch surface, with each said post to fit through a hole formed through the fender and receive an end of one of the bolts threaded shafts ends turned therein.

4. The saddle fender bender as recited in claim 2, wherein the posts are individually secured to the bar inner arch surface by soldering or brazing.

5. The saddle fender bender as recited in claim 1, wherein the bar arched inner surface is drilled and tapped at spaced intervals therealong, with each said tapped hole to receive the end of one of the bolts threaded shafts turned therein.

6. The saddle fender bender as recited in claim 1, wherein each bolt broad head includes a means formed into said bolt broad head to receive a turning tool fitted therein.

7. The saddle fender bender as recited in claim 6, wherein the means for receiving a turning tool is a side hole formed in the bolt broad head center to receive a phillips head screw driver end or an Allen wrench end.

8. The saddle fender bender as recited in claim 6, wherein the means for receiving a turning tool is a slot formed across the bolt broad head, passing across the center of said bolt broad head, to receive a screw driver blade fitted therein.
